(19) United States
(12) Patent Application Publication
(10) Pub. No.: US 2018/0058495 A1
(43) Pub. Date: Mar. 1, 2018

(54) UNIVERSAL ELECTRONICS LOCK

(71) Applicant: Donald R. Frantz, New Berlin, WI (US)

(72) Inventor: Donald R. Frantz, New Berlin, WI (US)

(21) Appl. No.: 15/794,489

(22) Filed: Oct. 26, 2017

Related U.S. Application Data
(63) Continuation of application No. 12/670,279, filed on Jan. 22, 2010.
(60) Provisional application No. 60/951,340, filed on Jul. 23, 2007.

(51) Int. Cl. F16B 41/00; E05B 73/00; B60R 11/02

(52) U.S. Cl. CPC F16B 41/005; E05B 73/0082; B60R 2011/0096; B60R 11/02; Y10T 70/5009

(57) ABSTRACT

A universal electronics lock has an inner cylinder and an outer cylinder. The outer cylinder slidingly fits over the inner cylinder. The outer cylinder is equipped with a lock cylinder that has an axially-movable latch. When the latch is in one position, it clears an inwardly-directed ridge defined within the inner cylinder. The lock is then in the “unlocked” position. When the latch is in a second position when rotated by a turning of a key, the latch is disposed behind a portion of the ridge and the lock is in the “locked” position. The universal electronics lock of the present invention allows rotation about a fastener, thus making the lock difficult to cut or saw through.

This application is a continuation of U.S. patent application Ser. No. 12/670,279 filed Jan. 22, 2010, which is the National Stage Entry into the United States Patent and Trademark Office from International PCT Patent Application No. PCT/US07/82215, having an international filing date of Oct. 23, 2007, and which claims the priority and benefit of U.S. Provisional Patent Application Ser. No. 60/951,340 filed Jul. 23, 2007, each of which is incorporated herein by reference in its their entireties.

### FIELD OF THE INVENTION

The present invention relates generally to locks and other security devices. More specifically, it relates to a universal lock that is used to secure an electronic device or instrument to a bracket by replacing or supplementing a threaded mounting portion of the electronic device or instrument, or of the bracket, with the universal lock.

### BACKGROUND OF THE INVENTION

There are many types of electronic instruments, such as marine sonar devices, global positioning devices (GPS), among others, that are designed to be installed onto a bracket by use of one or more fasteners. The instrument is typically configured with threaded holes in opposed sides of the body of the instrument, such holes aligning with those of the bracket. The fasteners are typically threaded to match that of the threaded holes of the instrument. This mounting configuration permits some vertical adjustability as well as angular adjustability of the instrument, which enhances the visibility of the instrument. By tightening the fastener or fasteners, the user can secure both the vertical position of the instrument and its angle of tilt.

In this inventor's experience, boaters prefer electronic instruments such as sonar to be raised off the console so they are more readily visible from a standing position, such as when the driver of the boat is standing at the wheel for better visibility. The valuable nature of GPS units and marine sonar units also makes them an easy potential target for thieves. To both ends, this inventor devised an electronics lock device that is disclosed and claimed in U.S. Pat. No. 7,243,514 entitled Method and Device for Securing an Electronic Instrument to a Bracket. While the device of that application is fully functional and has achieved much commercial success, this inventor is aware of the fact that the device disclosed and claimed in that application is not applied “universally” to all electronic devices or instruments and their associated bracketry.

Accordingly, this inventor has sought to devise another lock device that is universally applicable to the types of electronics and bracketry that exists in the marketplace, including electronics used with marine craft and land vehicles, such as trucks and automobiles, for example.

### SUMMARY OF THE INVENTION

What is needed is a universal electronics lock that can be used to securely and inexpensively lock electronic devices or instruments to brackets. The present invention provides such a device that, when used properly, helps to prevent theft of sonar devices and GPS units from the brackets they are normally installed on or mounted to.

The universal electronics lock of the present invention provides for a unique locking device having a substantially hollow inner cylinder and a substantially hollow outer cylinder. The outer cylinder slidingly fits over, and effectively overlaps, a portion of the inner cylinder. The outer cylinder is equipped with a locking device that has a latch in it. When the latch is in one position, it clears an inwardly-directed circumferential ridge that is disposed inwardly of the inner cylinder. The lock is then in the “unlocked” position. When the latch is rotated by a turning of a key in the lock, a “catch” portion of the latch is disposed behind the ridge and the lock is in the “locked” position. In order to completely remove the lock, and specifically the inner cylinder thereof, the user has to “back out” a threaded fastener. The idea behind the universal electronics lock of the present invention is that it allows rotation about the fastener, thus making the lock difficult to cut or saw through. The foregoing and other features of the universal electronics lock of the present invention will be apparent from the detailed description that follows.

### BRIEF DESCRIPTION OF THE DRAWINGS

FIG. 1 is a front elevational view of an electronics mounting bracket that has the electronic device attached to it using a preferred embodiment of a universal electronics lock constructed in accordance with the present invention.

FIG. 2 is an enlarged front elevational and partially cross-sectioned view of the universal electronics lock illustrated in FIG. 1 and showing the lock in the “locked” position.

FIG. 3 is a view similar to that illustrated in FIG. 2 and showing the universal electronics lock in the “unlocked” position.

FIG. 4 is an exploded front elevational and partially cross-sectioned view of the universal electronics lock illustrated in FIGS. 1-3.

FIG. 5 is a left side and cross-sectioned view of the universal electronics lock shown in the locked position and taken along line 5-5 of FIG. 2.

FIG. 6 is a view similar to that illustrated in FIG. 5 but showing the universal electronics lock in the unlocked position and taken along line 6-6 of FIG. 3

### DETAILED DESCRIPTION OF THE INVENTION

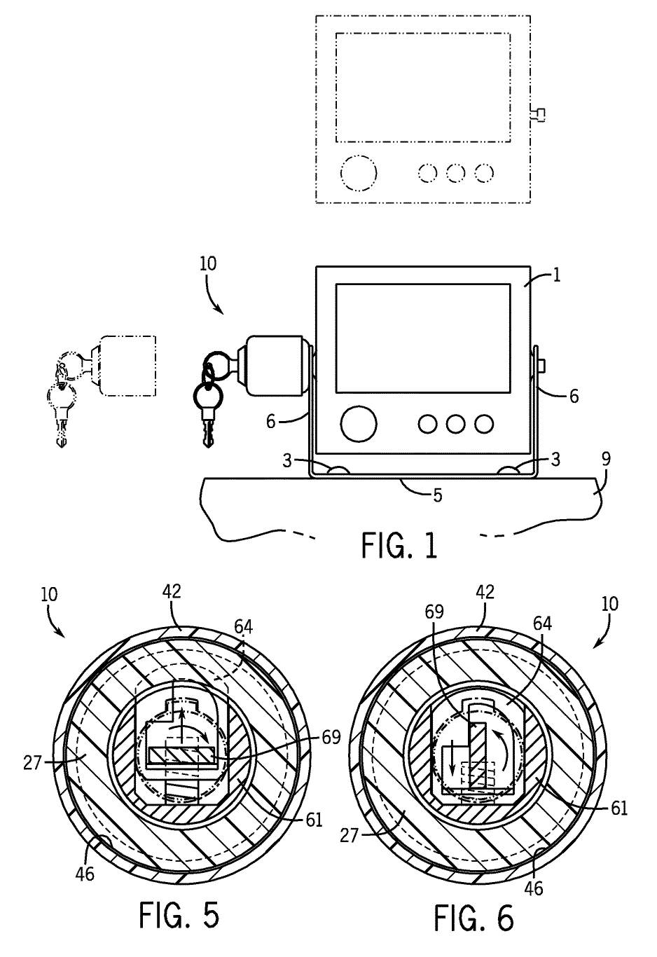

Referring now to the drawings in detail, wherein like numbered elements correspond to like elements throughout, FIG. 1 is a front elevational view of a universal electronics lock, generally identified 10, constructed in accordance with the present invention. As shown in FIG. 1, the lock 10 is used to secure an electronics device 1 to a bracket 5, the bracket 5 having a pair of opposing side legs 6. The bracket 5 is, in turn, secured to a surface 9 by means of one or more fasteners 3. It is to be understood that the universal electronics lock 10 of the present invention is not limited to use with this type of device 1, the type of device 1 not being a limitation of the present invention.

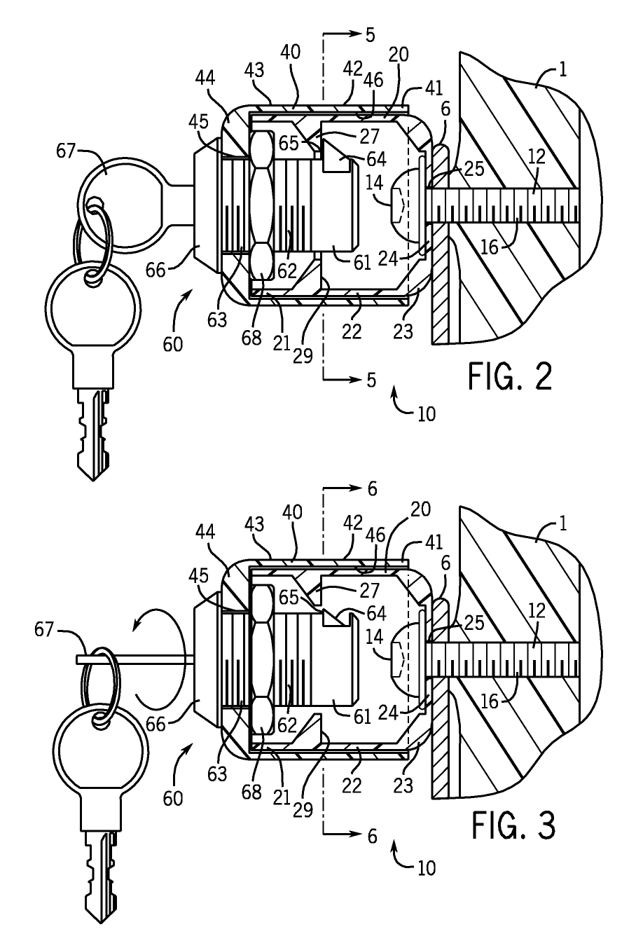

As shown in FIG. 2, it will be understood that the universal electronics lock 10 of the present invention comprises three key components. The first component is a substantially hollow and cup-shaped inner cylinder, generally identified 20. The second component is a substantially hollow and cup-shaped outer cylinder, generally identified 40. The third component is a means for securing the outer cylinder 40 to the inner cylinder 20, the securing means in the preferred embodiment comprising a lock cylinder assembly, generally identified 60. The outer cylinder 40 is functionally adapted and configured to slide over a portion of the inner cylinder 20 and, in this fashion, actually overlaps a substantial portion of the inner cylinder 20.

The inner cylinder 20 is a substantially hollow member comprising a cylindrically-shaped and continuous side wall 22. The cylindrical-shaped side wall 22 comprises an outer surface 26. The side wall 22 further comprises a first end 21 and a second end 23. The first end 21 of the side wall 22 forms a circular opening at that end 21. The second end 23 transitions into an end wall 24 that is integrally formed with the side wall 22 of the inner cylinder 20. The end wall 24 also includes a centrally-disposed aperture 25. The purpose of the aperture 25 will be apparent later in this detailed description.

Formed within the side wall 22 of the inner cylinder 20 is a circumferential ridge 27, the ridge 27 being formed from a portion of the side wall 22 and extending inwardly of the inner cylinder 20. It is to be understood, however, that the ridge 27 of the inner cylinder 20 could also be formed as an element that is manufactured separate and apart from the side wall 22 of the inner cylinder 20. For example, the ridge 27 could be formed into another cylinder (not shown) and that other cylinder could, in turn, be press-fit into the inner cylinder 22. However, forming the ridge 27 as described above is a design expediency that requires fewer parts and fewer steps in the manufacturing process to create in the view of this inventor. The innermost portion of the ridge 27 forms a circumferential shoulder 29. The purpose of the ridge 27 and shoulder 29 will also be apparent later in this detailed description. Finally, the inner cylinder 20 of the universal lock 10 can be fabricated of a plastic material in the preferred embodiment, but is not so limited. The inner cylinder 20 could, for example, be fabricated of a metal material, from a combination of metal and plastic components, or from carbon fiber impregnated nylon or plastic.

The outer cylinder 40 of the universal electronics lock 10 is a substantially hollow member similarly comprising a cylindrically-shaped and continuous side wall 42. The cylindrically-shaped side wall 42 of the outer cylinder 40 comprises an inner surface 46. In the preferred embodiment, the diameter of the inner surface 46 of the side wall 42 of the outer cylinder is slightly larger than the diameter of the outer surface 26 of the inner cylinder 20 such that the two elements can overlap or “nest” in a way whereby the inner cylinder 20 is slidably receivable within a portion of the outer cylinder 40. The side wall 42 of the outer cylinder 40 further comprises a first end 41 and a second end 43. The first end 41 of the side wall 42 forms a circular opening at that end 41. The second end 43 transitions into an end wall 44 that is integrally formed with the side wall 42 of the outer cylinder 40. The end wall 44 also includes a centrally-disposed aperture 45. This particular aperture 45 is formed to receive a portion of the lock cylinder 60 within it. In the preferred embodiment, the outer cylinder 40 is also fabricated of a plastic or metal material and is variably fabricated as stated above with respect to the inner cylinder 20.

The lock cylinder assembly 60 comprises a lock cylinder body 62 having a first end 61 and a second end 63. A spring-loaded and axially-movable, or outwardly-movable (relative to the central axis of the lock cylinder body 62), latch 64 is incorporated into the first end 61 of the lock cylinder body 62. As shown in FIG. 1, the latch 64 includes a shoulder 65. The second end 63 of the lock cylinder body 62 is threaded so as to be mountable to the outer cylinder 40 by means of a ring nut 68. The second end 63 of the lock cylinder body 62 also includes a flanged portion 66. In the universal lock 10 of the present invention, the flanged portion 66 of the lock cylinder body 62 is disposed at the outer surface of the end wall 44 of the outer cylinder 40, the remainder of the lock cylinder body 62 extending through the aperture 45 of the end wall 44. In this fashion, the ring nut 68 and the latch 64 may be secured to the lock cylinder body 62 to secure the lock cylinder 60 to the outer cylinder 40. In the preferred embodiment of this universal electronics lock 10, the lock cylinder 60 is comprised of a metal material. It is to be understood that alternative configurations of the lock cylinder assembly 60 could be used, as long as such assembly 60 included an axially-movable latch 64 and latch shoulder 65.

The lock cylinder 60 is operated by turning a key 67 in the lock cylinder 62 in one direction, wherein the latch 64 of the lock cylinder 60 is extended outwardly (as shown in FIGS. 2 and 5) to engage the ridge 27 of the inner cylinder 20. This corresponds to the “locked” position of the universal electronics lock 10. In the “locked” position, the shoulder 65 of the latch 64 is adjacent the shoulder 29 of the ridge 27, thereby engaging the inner and outer cylinders 20, 40. When the key 67 is rotated, latch 64 is withdrawn into the lock cylinder 60 and the opposite is true. That is, this corresponds to the “unlocked” position of the universal electronics lock 10 (as shown in FIGS. 3, 4 and 6). It is also to be noted by closely examining FIGS. 5 and 6 that a rotatable tab 69 is used within the lock cylinder assembly 60 to move the latch 64 and latch shoulder 65 into (FIG. 5) and out of (FIG. 6) engagement with the ridge 27 and ridge shoulder 29.

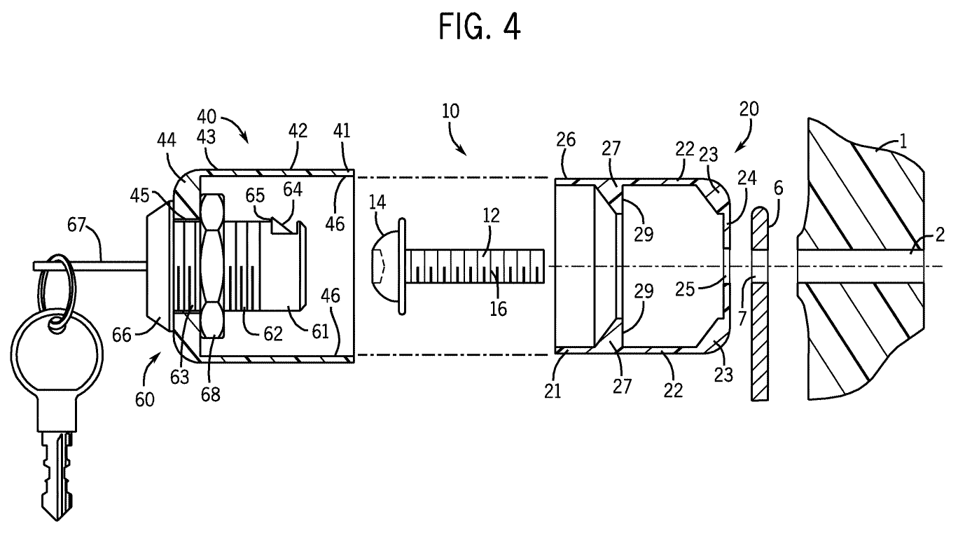

In application, the user would remove the fastener 12 that would normally be used to attach the electronic device 1 to one upright leg 6 of the bracket 5, the bracket 6 having an aperture 7 defined in it and the electronic device 1 having an aperture 2 defined in it. See FIG. 4. Such attachment would also be similar to that shown in U.S. Pat. No. 7,243,514, for example. The user would then insert the threaded portion 16 of the fastener 12 through the aperture 25 of the inner cylinder 20 such that the head 14 of the fastener 12 is disposed to the interior of the inner cylinder 20. The user would then insert the threaded portion 16 of the fastener 12 through the aperture 7 of the bracket leg 6 and into the aperture 2 of the electronic device 1. See FIG. 4. The outer cylinder 40 is then slid over the outer surface 26 of the inner cylinder 20. When the outer cylinder 40 is fully engaged with the inner cylinder 20, the key 67 can be rotated thereby releasing the latch 64 into locking position with the ridge 27 of the inner cylinder 20 as shown in FIG. 2. Significant in this invention is that the outer cylinder 40 can be presented to the inner cylinder 20 in virtually any position where the outer cylinder 40 overlaps the inner cylinder 20 and the latch 64 will always be in a position to “catch” a portion of the ridge 27 of the inner cylinder 20 in any position. In this position, the fastener 12 is rendered inaccessible by the overlapped and secured inner and outer cylinders 20, 40, respectively. Thus, it will be appreciated that the universal electronics lock 10 of the present invention allows rotation about the fastener 12, thus making the lock 10 difficult to cut or saw through. To unlock the universal electronics lock 10, the opposite of these steps would be done.

Additional advantages and modifications will readily occur to those skilled in the art. Therefore, the invention in its broader aspects is not limited to the specific details disclosed and described herein. Accordingly, various modifications may be made without departing from the spirit or scope of the general inventive concept.

What is claimed is:

1. A universal lock for use with an electronics device, the electronics device including a threaded aperture defined in the electronics device for receiving a like-threaded fastener, the electronics device further including a bracket, the bracket having a first leg and an aperture in the first leg such that the bracket can be secured to the device by passing a like-threaded fastener through the bracket aperture and into the threaded aperture of the electronics device, the lock comprising:
a threaded fastener comprising a head and a threaded portion having threads that are complementary to threads of a threaded aperture of an electronics device;
a substantially hollow and cup-shaped inner cylinder comprising:
a cylindrically-shaped side wall, the side wall comprising a cylindrical outer surface having an outer diameter;
an end wall with a centrally disposed aperture defined in the end wall, the aperture of the inner cylinder end wall being configured to permit the threaded portion of the fastener to pass therethrough such that the inner cylinder is securable to an electronics device when the threaded portion of the fastener passes through an aperture of a leg of an electronics bracket, the centrally disposed aperture being sized so as to retain the fastener head within the inner cylinder; and
a circumferential ridge formed within the inner cylinder, said ridge extending inwardly of the inner cylindrically-shaped side wall of the inner cylinder and comprising a ridge shoulder;
wherein the side wall, the end wall and the ridge of the inner cylinder are integrally formed;
a substantially hollow and cup-shaped outer cylinder comprising:
a cylindrically-shaped side wall, the side wall comprising a cylindrical inner surface having an inner diameter, the inner diameter being slightly larger in diameter than the outer diameter of the inner cylinder;
an open first end; and
a second end including an aperture;
wherein the cylindrically-shaped inner side wall of the outer cylinder slidingly overlaps a substantial portion of the cylindrically-shaped side wall outer surface of the inner cylinder; and
wherein the side wall and the second end of the outer cylinder are integrally formed;
a lock cylinder assembly comprising:
a lock cylinder, the lock cylinder comprising a first end and a second end, the first end of the lock cylinder being mounted in the second end of the outer cylinder;
an outwardly-movable latch, the latch comprising a latch shoulder to engage the ridge shoulder of the inner cylinder in the locked position for securing the cup-shaped inner cylinder in any circumferential position relative to the cup-shaped outer cylinder such that the outer cylinder cannot be removed from the inner cylinder but can rotate freely relative to the inner cylinder in that locked position such that the fastener is rendered inaccessible and wherein the outer cylinder and lock cylinder assembly is removable from the inner cylinder when the lock cylinder assembly is in the unlocked position so as to access the head of the fastener by actuation of the lock cylinder assembly to withdraw the outwardly-movable latch and disengage it from the ridge shoulder of the inner cylinder;
wherein a leg of a bracket is captured between an electronics device and the end wall of the inner cylinder;
wherein the fastener is rendered inaccessible by the overlapped and secured inner and outer cylinders; and
wherein the lock is rotatable about the fastener.

2. The lock of claim 1 wherein the inner and outer cylinders are made of metal.

3. The lock of claim 1 wherein the inner and outer cylinders are made of plastic.

4. The lock of claim 1 wherein the inner and outer cylinders are made of a carbon fiber impregnated plastic.

5. The lock of claim 1 wherein the inner and outer cylinders are made of a carbon fiber impregnated nylon.

6. A universal lock and electronics device combination comprising:
an electronics device comprising a threaded aperture defined in the electronics device and a bracket, the bracket having a leg and an aperture in the leg such that the bracket can be secured to the device by passing a like-threaded fastener through the aperture of the bracket leg and into the threaded aperture of the electronics device;
a lock, the lock comprising:
a threaded fastener, the fastener comprising a threaded portion that is threaded to match the threaded aperture of the electronics device and a head;
a substantially hollow and cup-shaped inner cylinder, the inner cylinder comprising a cylindrically-shaped side wall, the cylindrically-shaped side wall comprising a cylindrical outer surface having an outer diameter, an open first end, a wall disposed at a second end, a circumferential rounded portion disposed between the cylindrical outer surface and the second end, and a centrally disposed aperture defined in the second end, the aperture being configured to permit the threaded portion of the fastener to pass through it such that the inner cylinder is securable to the first leg of the bracket, the centrally disposed aperture being sized so as to enclose the head of the fastener within the inner cylinder, the inner cylinder further comprising a circumferential ridge formed within the inner cylinder, the ridge extending inwardly of the inner cylindrically-shaped side wall of the inner cylinder and forming a ridge shoulder;
wherein the side wall, the rounded portion, the second end, and the ridge of the inner cylinder are integrally formed;
a substantially hollow and cup-shaped outer cylinder, the outer cylinder comprising a cylindrically-shaped inner side wall and a cylindrically-shaped outer side wall and further comprising a first end and a second end, the second end of the outer cylinder including an aperture, the substantially hollow and cup-shaped outer cylinder having an inner diameter being slightly larger in diameter than the outer diameter of the inner cylinder;
wherein the side wall and the second end of the outer cylinder are integrally formed; and
a lock cylinder assembly disposed centrally within the outer cylinder, the lock cylinder assembly comprising a lock cylinder, the lock cylinder comprising a first end and a second end, the first end of the lock cylinder being mounted to the outer cylinder at the second end of the outer cylinder, and the lock cylinder further comprising an outwardly-movable latch, the outwardly-movable latch comprising a latch shoulder that engages the ridge shoulder of the inner cylinder in the locked position for securing the cup-shaped inner cylinder in any circumferential position relative to the cup-shaped outer cylinder such that the outer cylinder cannot be removed from the inner cylinder but can rotate freely relative to the inner cylinder in that locked position such that the fastener is rendered inaccessible by the secured inner and outer cylinders and wherein the outer cylinder and lock cylinder assembly is removable from the inner cylinder when the lock cylinder assembly is in the unlocked position so as to access the head of the fastener by actuation of the lock cylinder assembly to withdraw the outwardly-movable latch and disengage it from the ridge shoulder of the inner cylinder;
wherein the inner side wall of the outer cylinder slidingly overlaps substantially all of the side wall of the inner cylinder;
wherein the leg of the bracket is captured between the electronics device and the end wall at the second end of the inner cylinder when the outer cylinder is locked to the inner cylinder;
wherein the fastener and its head are rendered inaccessible when the outer cylinder is locked to the inner cylinder; and
wherein the lock is rotatable about the fastener.

7. The combination of claim 6 wherein the inner and outer cylinders are made of metal.

8. The combination of claim 6 wherein the inner and outer cylinders are made of plastic.

9. The combination of claim 6 wherein the inner and outer cylinders are made of a carbon fiber impregnated plastic.

10. The combination of claim 6 wherein the inner and outer cylinders are made of a carbon fiber impregnated nylon.

11. A universal lock and electronics device combination consisting of:
an electronics device having a threaded aperture defined in the electronics device and a bracket, the bracket having a first leg and an aperture in the first leg such that the bracket can be secured to the device by passing a like-threaded fastener through the aperture of the bracket and into the threaded aperture of the electronics device;
a lock, the lock consisting of:
a threaded fastener, the fastener having a head and a threaded portion that is threaded to match the threaded aperture of the electronics device;
a substantially hollow and cup-shaped inner cylinder, the inner cylinder having a cylindrically-shaped side wall, the cylindrically-shaped side wall having a cylindrical outer surface having an outer diameter, an open first end, a second end, a rounded portion disposed between the cylindrical outer surface and the wall of the second end, and a centrally disposed aperture defined in the wall of the second end, the aperture being configured to permit the threaded portion of the fastener to pass through it such that the inner cylinder is securable to the first leg of the bracket, the centrally disposed aperture being sized so as to enclose the head of the fastener within the inner cylinder, the inner cylinder further having a circumferentially-defined ridge formed within the inner cylinder, said ridge extending inwardly of the inner cylindrically-shaped side wall of the inner cylinder and forming a ridge shoulder;
wherein the side wall, the rounded portion, the wall of the second end, and the ridge of the inner cylinder are integrally formed;
a substantially hollow and cup-shaped outer cylinder, the outer cylinder having a cylindrically-shaped inner side wall and a cylindrically-shaped outer side wall and further having a first end and a second end, the second end of the outer cylinder including an aperture, the substantially hollow and cup-shaped outer cylinder having an inner diameter being slightly larger in diameter than the outer diameter of the inner cylinder;
wherein the side wall and the second end of the outer cylinder are integrally formed; and
a lock cylinder assembly disposed centrally within the outer cylinder, the lock cylinder assembly consisting of a lock cylinder, the lock cylinder having a first end and a second end, the first end of the lock cylinder being mountable at the second end of the outer cylinder, and the lock cylinder further comprising an outwardly-movable latch, the outwardly-movable latch being designed to engage with the ridge shoulder of the inner cylinder in the locked position for securing the cup-shaped inner cylinder in any circumferential position relative to the cup-shaped outer cylinder such that the outer cylinder cannot be removed from the inner cylinder but can rotate freely relative to the inner cylinder in that locked position such that the fastener is rendered inaccessible by the secured inner and outer cylinders and wherein the outer cylinder and lock cylinder assembly is removable from the inner cylinder when the lock cylinder assembly is in the unlocked position so as to access the head of the fastener by actuation of the lock cylinder assembly to withdraw the outwardly-movable latch and disengage it from the ridge shoulder of the inner cylinder;
wherein the inner side wall of the outer cylinder slidingly overlaps substantially all of the side wall of the inner cylinder;
wherein the leg of the bracket is captured between the electronics device and the wall of the second end of the inner cylinder when the outer cylinder is locked to the inner cylinder;
wherein the fastener and its head are rendered inaccessible when the outer cylinder is locked to the inner cylinder; and
wherein the lock is rotatable about the fastener.

12. The combination of claim 11 wherein the inner and outer cylinders are made of metal.

13. The combination of claim 11 wherein the inner and outer cylinders are made of plastic.

14. The combination of claim 11 wherein the inner and outer cylinders are made of a carbon fiber impregnated plastic.

15. The combination of claim 11 wherein the inner and outer cylinders are made of a carbon fiber impregnated nylon.
